(19) United States
(12) Patent Application Publication
(10) Pub. No.: US 2026/0131590 A1
(43) Pub. Date: May 14, 2026

(54) Chapter Chambers: Thematic Book Integrated Compartmentalized

(71) Applicant: Terrance Zack Dominguez-Hover, Canandaigua, NY (US)

(72) Inventor: Terrance Zack Dominguez-Hover, Canandaigua, NY (US)

(21) Appl. No.: 19/434,871

(22) Filed: Dec. 29, 2025

(51) Int. Cl. B42D 9/00; A47F 1/06

(52) U.S. Cl. CPC B42D 9/001; A47F 1/06; B42P 2201/00

(57) ABSTRACT

A chapter-synchronized item-dispensing system is disclosed. The device includes a main housing, a book retention slot, multiple chapter access doors, and an internal item-holder assembly that stores and aligns thematic items with corresponding book chapters. The retention slot secures a book without interfering with internal components. Each access door opens to a dedicated compartment, allowing readers to retrieve chapter-specific items sequentially as they progress through the narrative. The internal assembly features a compartmentalized tray with alignment structures that maintain accurate positioning between compartments and doors, preventing item displacement during handling. The system accommodates various materials, door mechanisms, tray layouts, and thematic designs, supporting customizable, refillable, or single-use formats. By combining book storage, controlled chapter-based access, and reliable item retention in a unified structure, the invention enhances reader engagement and offers a flexible platform for authors, publishers, and merchandise creators.

### CROSS-REFERENCE TO RELATED APPLICATIONS

None.

### 1. TECHNICAL FIELD

The present invention relates to interactive packaging and display systems. More specifically, it concerns a compartmentalized enclosure configured to retain a book and dispense chapter-specific items through selectively accessible doors, thereby enhancing narrative engagement through coordinated physical interaction.

### 2. BACKGROUND OF THE INVENTION

Traditional book packaging provides minimal interactivity and does not offer a structured method for delivering chapter-specific items or collectibles. Advent-style calendars provide sequential access to items but lack integration with books, narrative alignment, or a unified system combining book storage, chapter-based access, and item retention.

There is a need for a device that synchronizes item retrieval with reading progression, enhances reader engagement, and provides a modular, customizable platform for authors, publishers, and merchandise creators. The present invention fulfills this need.

### 3. SUMMARY OF THE INVENTION

The invention provides a multi-component display box configured to house a book and deliver thematic items corresponding to individual chapters. The system includes a main housing, a book retention slot, a plurality of chapter access doors, and an internal item holder assembly comprising a compartmentalized tray. These components cooperate to create a sequential, chapter-aligned reveal experience that enhances reader engagement and supports narrative progression.

The invention is adaptable to various materials, door mechanisms, tray configurations, and thematic designs, ensuring broad applicability and preventing design-around attempts.

### 4. BRIEF DESCRIPTION OF THE DRAWINGS

FIG. 1 Reference Language

Referring now to FIG. 1, an embodiment of the chapter-synchronized item dispensing system is shown. The system includes a main housing (100.) defining an interior volume, a book retention slot (110.) formed in the housing, a plurality of chapter access doors (120.) positioned on the front surface, and an internal item holder assembly (130.) positioned within the interior volume, which is illustrated in broken lines.

FIG. 2 Reference Language

As shown in FIG. 2, the book retention slot 110 is formed in the side surface of the main housing 100 and is configured to receive a book 150, which is illustrated in broken lines. The slot may include side walls and a bottom panel to provide friction-fit retention or accommodate adjustable mechanisms. The geometry of the slot enables secure placement of the book without interfering with the internal item holder assembly.

FIG. 3 Reference Language

Turning to FIG. 3, the internal item holder assembly (130.) includes a plurality of compartments (132.) arranged in a grid pattern. Alignment features (134.) are provided along the tray edges to ensure proper positioning within the main housing.

FIG. 4 Reference Language

As shown in FIG. 4, the chapter access door (120.) is positioned on the top surface of the main housing (100.) and is aligned with a corresponding compartment (132.) of the internal item holder assembly (130.), enabling chapter-specific item retrieval. The book retention slot (120.) is located adjacent to the door layout and is configured to receive a book (150.) which is illustrated in broken lines. The top view confirms that the book slot and chapter doors are spatially coordinated to support synchronized reading and item access.

FIG. 5 Reference Language

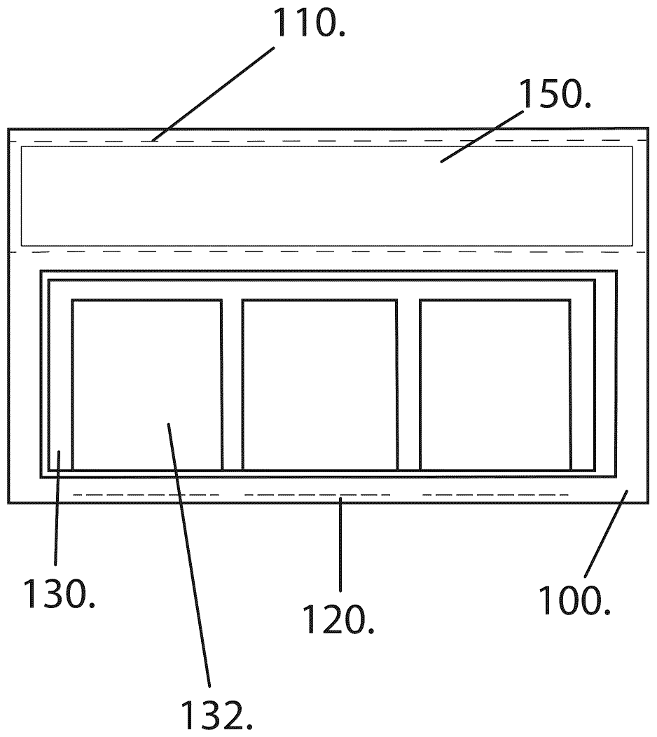

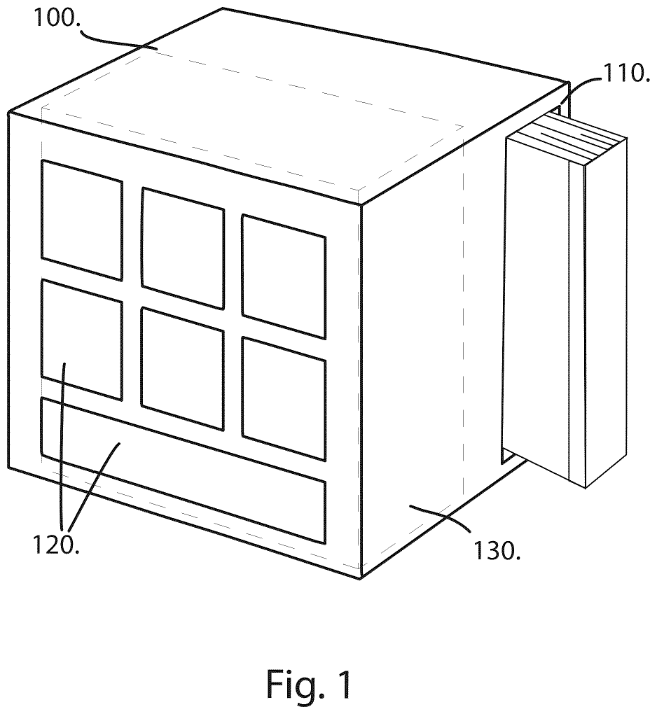

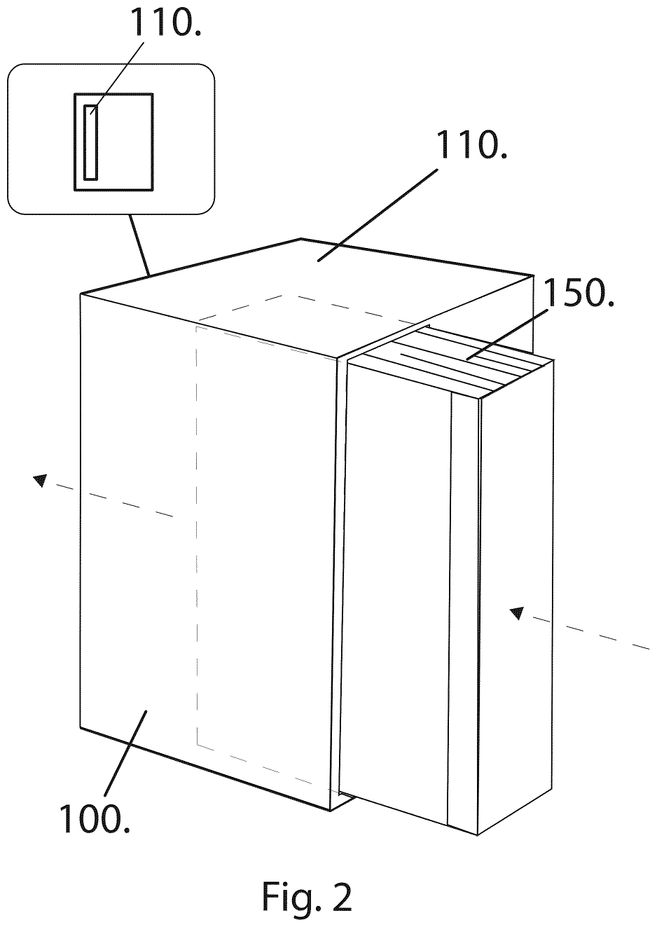

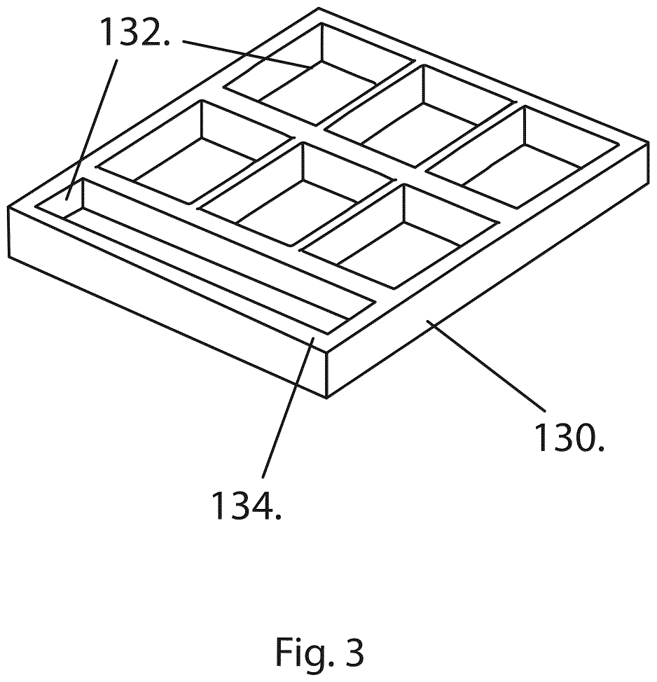

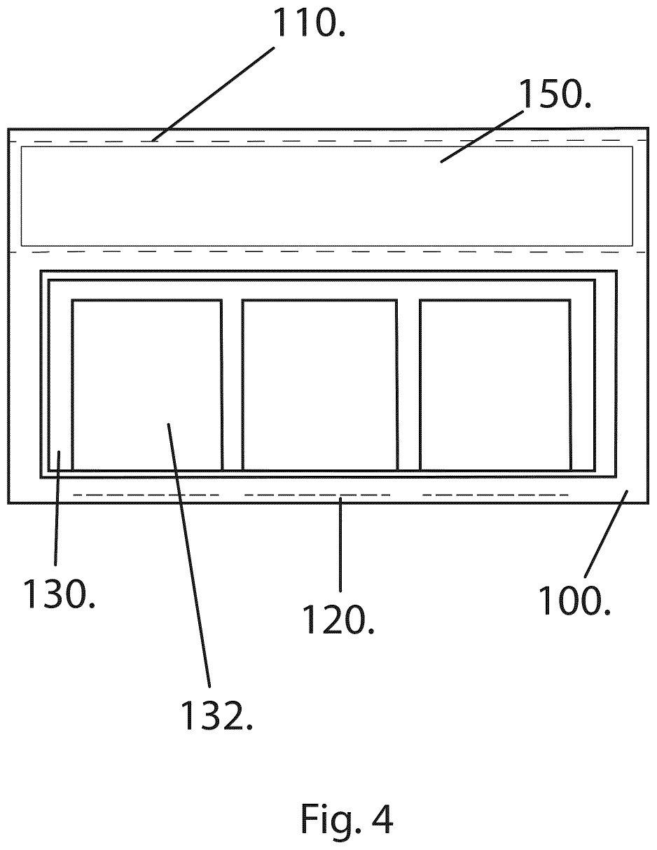

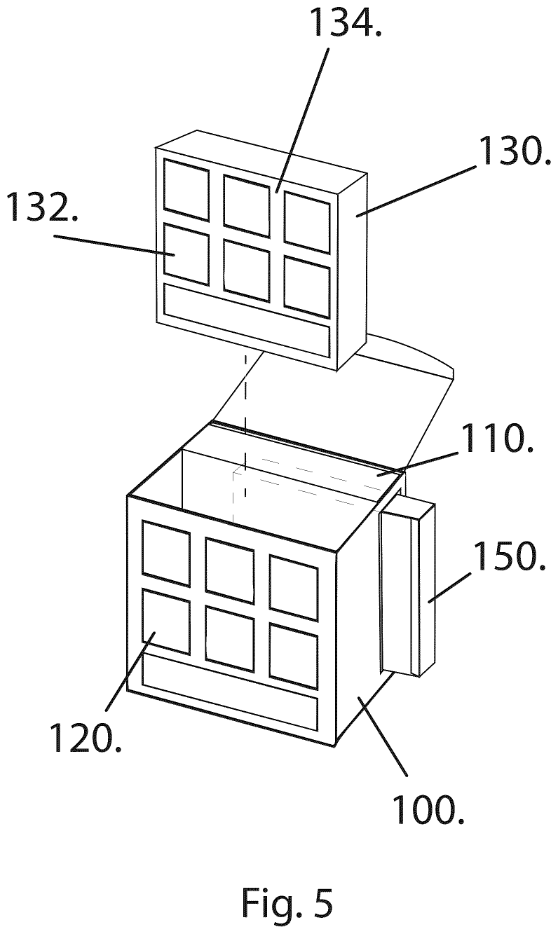

Referring to FIG. 5, an exploded view of the chapter-synchronized item dispensing system is shown. The main housing (100.) defines an interior cavity configured to receive the internal item holder assembly (130.), which includes a plurality of compartments (132.) for storing chapter-specific items. Alignment features (134.) are positioned along the tray edges to ensure secure and accurate placement within the housing. Above the tray, a book retention slot (110.) is configured to receive a book (150.), shown in broken lines. The chapter access doors (120.) are arranged on the front surface of the housing and correspond to the compartments below.

### 5. DETAILED DESCRIPTION OF THE INVENTION

### 5.1 Overview

The device, referred to herein as Chapter Chambers, comprises:
Main Housing Structure
Book Retention Slot
Chapter Access Doors
Internal Item Holder Assembly

All components are structurally and functionally integrated to ensure reliable alignment between chapter doors and the items retained behind them.

### 5.2 Main Housing Structure

The main housing is generally rectangular and may be manufactured in various sizes, including but not limited to:
Height: 6-12 inches
Length: 4-12 inches
Width: 4-12 inches

### Materials

The housing may be formed from:
Cardboard
Cardstock
Wood
Plastic
3D-printed polymers
Any equivalent structural material

### Surface Features

External surfaces may include printed imagery, text, graphics, QR codes, or thematic artwork.

### Function

Provides structural support, protects internal components, and forms the external interface through which the user interacts with the device.

### 5.3 Book Retention Slot

The Book Retention Slot is positioned on the top surface or a side wall of the housing.

### Configuration

Formed as a recessed cavity or sleeve adapted to receive a book of varying thicknesses.
May include friction-fit edges, a push-pull mechanism, or equivalent retention means.
May be oriented vertically or horizontally.

### Function

Secures the book within the device while allowing user access without disturbing the internal item compartments.

### 5.4 Chapter Access Doors

A plurality of doors are arranged on the front or side surfaces of the housing. Each door corresponds to a specific chapter of the book.

### Door Geometry

Doors may be:
Square
Rectangular
Circular
Thematic or custom shapes

### Door Mechanisms

In various embodiments:
Perforated punch-through doors
Hinged doors
Magnetically latched doors
Key-locked doors
Any equivalent access mechanism

### Function

Provides selective, chapter-specific access to the internal item compartments.

### 5.5 Internal Item Holder Assembly

Positioned directly behind each Chapter Access Door, the Internal Item Holder Assembly comprises a molded insert or tray configured to retain chapter-specific items in fixed alignment with their corresponding doors.

### Structural Features

The assembly includes:
A compartmentalized thermoformed tray comprising a grid of recessed cells or divots.
A multicell retention matrix engineered to prevent item displacement during shipping, handling, or user interaction.
Clear or opaque durable construction enabling quality inspection and consistent presentation.
Optional removable or permanently affixed installation, allowing for refillable, customizable, or single-use configurations.
Alignment features, ensuring each compartment is positioned directly behind its corresponding chapter door.

### Item Compatibility

Each compartment may retain:
Stickers
Trinkets
Collectibles
Foreshadowing tokens
Chapter-themed accessories
Any small item associated with narrative content

### Function

Maintains item position, ensures alignment with chapter doors, and supports the sequential reveal experience central to the invention.

### 6. Operation of the Device

The user inserts or removes a book from the Book Retention Slot.
Upon reaching a designated chapter, the user opens the corresponding Chapter Access Door.
Depending on the embodiment, the door may be punched through, hinged open, magnetically released, or unlocked.
The user retrieves the thematic item retained within the aligned compartment of the Internal Item Holder Assembly.
The process repeats for each chapter, creating a synchronized reading and item-retrieval experience.

### 7. Embodiments and Variations

The following embodiments illustrate the range of configurations, materials, mechanisms, and structural variations applicable to the Chapter Chambers system. These embodiments are non-limiting and may be combined in any suitable manner.

### 7.1 Housing Variations

The main housing may be constructed in any of the following forms:

### Materials

Cardboard, cardstock, corrugated board
Wood (plywood, MDF, bamboo, hardwood)
Plastics (ABS, PET, PVC, HDPE)
3D-printed polymers (PLA, resin, nylon)
Metal sheets (aluminum, tin)
Composite laminates
Fold-flat die-cut blanks for low-cost shipping

### Structural Variations

Single-piece folded housing
Multi-panel housing assembled with adhesives, tabs, or fasteners
Rigid box with removable lid
Clamshell housing with hinge
Modular housing with detachable sections
Expandable or collapsible housing for adjustable book sizes

### 7.2 Book Retention Slot Variations

The book slot may be configured in multiple ways, including:

### Geometry

Rectangular sleeve
U-shaped channel
Adjustable-width slot using elastic bands, sliding rails, or spring-loaded clamps
Vertical or horizontal orientation
Side-loading, top-loading, or front-loading configurations

### Retention Mechanisms

Friction-fit edges
Magnetic retention
Velcro-based retention
Sliding clamp mechanism
Elastic tension straps
Ratcheting or locking book-holder frame

### 7.3 Chapter Access Door Variations

The chapter doors may vary in shape, mechanism, and placement.

### Door Shapes

Square, rectangular, circular
Thematic shapes (stars, gears, animals, symbols)
Embossed or debossed doors
Multi-layer doors with decorative overlays

### Door Mechanisms

Perforated punch-through doors
Hinged doors (living hinge, mechanical hinge, film hinge)
Magnetically latched doors
Snap-fit or friction-fit doors
Sliding doors
Rotating or pivoting doors
Key-locked or coded doors for premium editions
Tear-strip doors for tamper-evident packaging

### Door Placement

Front face
Side faces
Top face
Distributed around multiple surfaces for multi-angle interaction

### 7.4 Internal Item Holder Assembly Variations

The internal tray may be configured in numerous ways to accommodate different item types and manufacturing methods.

### Tray Structures

Thermoformed plastic tray
Molded pulp tray
Foam insert with cutouts
3D-printed tray
Cardboard grid insert
Multi-layer tray with stacked compartments
Rotating carousel tray
Sliding drawer-style tray

### Compartment Variations

Uniform grid of cells
Irregular or thematic compartment shapes
Deep or shallow compartments
Adjustable dividers
Compartments with lids or seals
Compartments with cushioning or protective liners

### Tray-to-Door Alignment Mechanisms

Molded alignment ribs
Guide rails
Keyed positioning tabs
Magnetic alignment points
Adhesive or snap-fit mounting
Floating tray with internal stabilizers

### Installation Options

Permanently affixed
Removable and refillable
Replaceable cartridge-style trays
Swappable trays for different book editions

### 7.5 Optional Electronic or Smart Features

In certain embodiments, the device may include:
LED indicators that illuminate when a chapter is reached
NFC or RFID tags embedded behind doors
QR codes linking to digital content
Sound modules triggered upon door opening
Electronic locks that unlock sequentially
Sensors detecting door openings for gamified experiences

### 7.6 Multi-Book and Multi-Chapter Configurations

Alternative embodiments may include:
Housing designed for multiple books
Multi-volume series boxes
Extended chapter counts (e.g., 20-50 doors)
Double-sided or wrap-around door layouts
Multi-tiered trays for long novels or anthologies

### 7.7 Thematic and Custom Editions

The device may be customized for:
Fantasy, sci-fi, romance, mystery, or educational themes
Branded merchandise tie-ins
Collector's editions with premium finishes
Seasonal or holiday-themed versions
Author-signed editions with hidden compartments

### 8. Advantages

Provides chapter-synchronized item dispensing not found in conventional packaging.
Enhances literary engagement through physical interaction.
Supports multiple material formats and price points.
Offers modularity for series-based storytelling and sequel promotion.
Integrates book storage, item retention, and chapter-based access into a unified system.
Prevents item displacement through a dedicated multi-cell retention matrix.
Enables controlled, sequential access aligned with narrative progression.

### 9. Construction of Main Housing

The main housing may be formed from a single sheet or multiple panels depending on the material.

### 9.1 Folded-Panel Construction (Cardboard/Cardstock Embodiments)

In one embodiment, the housing is produced from a die-cut blank comprising:
A front panel
A rear panel
Two side panels
A top panel
A bottom panel
One or more glue flaps

The blank is folded along pre-scored lines and secured using:
Adhesive bonding
Mechanical tabs
Double-sided tape
Hot-melt glue

This construction method allows mass production using standard packaging machinery.

### 9.2 Rigid Box Construction (Wood/Plastic Embodiments)

In another embodiment, the housing is formed from:
Four side walls
A top wall
A bottom wall

These components may be:
Laser-cut (wood)
Injection-molded (plastic)
CNC-milled (wood or plastic)
3D-printed as a single monolithic shell

The walls may be joined using:
Adhesive
Screws
Snap-fit joints
Dovetail or tongue-and-groove joints

### 10. Construction of the Book Retention Slot

The book slot is dimensioned to receive a book of variable thickness.

### 10.1 Fixed-Dimension Slot

In one embodiment, the slot is a rectangular cavity formed by:
A bottom support panel
Two lateral guide walls
A rear stop wall

The cavity depth is selected to accommodate standard paperback or hardcover dimensions.

### 10.2 Adjustable Slot

In another embodiment, the slot includes:
A sliding rail system
A spring-loaded clamp
Elastic retention bands
A telescoping wall assembly

These mechanisms allow the slot to expand or contract to fit books of different thicknesses.

### 10.3 Slot Manufacturing

The slot may be:
Cut directly into the housing wall
Formed as a separate sleeve and adhered inside the housing
Molded as part of a monolithic plastic housing

### 11. Construction of the Chapter Access Doors

Each chapter door is aligned with a corresponding compartment in the internal tray.

### 11.1 Perforated Doors

For cardboard/cardstock embodiments:
Doors are created by die-cutting perforation lines
The perforation density determines the force required to open
A hinge line may be scored to control opening direction

### 11.2 Hinged Doors

For premium embodiments:
Doors may be attached using a living hinge (plastic)
Doors may be attached using a mechanical hinge (metal pin or knuckle)
Doors may be attached using a film hinge (thin flexible polymer strip)

### 11.3 Magnetic or Latching Doors

Doors may include:
Embedded magnets
Snap-fit tabs
Friction-fit edges
Key-lock mechanisms

### 12. Construction of the Internal Item Holder Assembly

The internal tray is engineered to maintain alignment with the chapter doors and prevent item displacement.

### 12.1 Tray Manufacturing

The tray may be:
Thermoformed from PET, PVC, or similar plastics
Molded from pulp or foam
3D-printed with integrated compartments
Cut from foam sheets with CNC or die-cutting

### 12.2 Compartment Geometry

Each compartment may include:
A recessed cavity sized to retain a small item
A tapered wall profile to facilitate removal
A flat or contoured bottom surface
Optional cushioning or liners

### 12.3 Tray-to-Housing Alignment

To ensure each compartment aligns with its corresponding door, the tray may include:
Alignment ribs that mate with grooves in the housing
Keyed tabs that lock into receiving slots
Magnetic alignment points
Adhesive pads securing the tray in a fixed position
Snap-fit retention features molded into the housing interior

### 12.4 Anti-Shift Features

To prevent item movement during shipping:
Each compartment may include a retention lip
Foam inserts may be added
A transparent cover film may be heat-sealed over the tray
A secondary inner lid may be included

### 13. Assembly of the Device

The assembly process may include:
1. Forming or assembling the main housing
2. Installing the book retention slot
3. Inserting and securing the internal tray
4. Aligning the tray compartments with the chapter doors
5. Loading chapter-specific items into the compartments
6. Closing or sealing the housing
7. Applying external graphics, labels, or thematic artwork

This sequence ensures consistent alignment and reliable operation.

### 14. Operation of the Device (Expanded Enablement)

A user operates the device as follows:
1. Inserts a book into the retention slot
2. Reads until reaching a designated chapter
3. Locates the corresponding chapter door
4. Opens the door using the mechanism provided (punch-through, hinge, latch, etc.)
5. Retrieves the item from the aligned compartment
6. Repeats the process for each chapter

The alignment features ensure that each door reveals the correct item without cross-contamination between compartments.

1. A chapter-synchronized item dispensing system comprising: a main housing defining an interior volume; a book retention slot formed in the housing and configured to receive a book; a plurality of chapter access doors positioned on at least one exterior surface of the housing, each chapter access door corresponding to a respective chapter of the book; and an internal item holder assembly positioned within the interior volume and comprising a plurality of compartments, each compartment aligned with a corresponding chapter access door; wherein opening a selected chapter access door provides user access to the compartment aligned with the selected chapter access door, thereby enabling chapter-specific retrieval of an item in synchronization with reading progression of the book.

2. A method of dispensing chapter-specific items in synchronization with reading progression of a book, the method comprising: receiving the book within a book retention slot of a main housing; providing a plurality of chapter access doors on an exterior surface of the main housing, each chapter access door corresponding to a respective chapter of the book; positioning an internal item holder assembly within the main housing, the internal item holder assembly comprising a plurality of compartments aligned with the chapter access doors; associating a chapter-specific item with each compartment; and opening a selected chapter access door upon reaching a corresponding chapter in the book to access the chapter-specific item retained within the aligned compartment.

3. The system of claim 1, wherein the main housing is constructed from cardboard, cardstock, wood, plastic, 3D-printed polymer, metal, or any combination thereof.

4. The system of claim 1, wherein the main housing comprises a fold-flat die-cut blank configured for assembly by folding along pre-scored lines.

5. The system of claim 1, wherein the main housing comprises a rigid box formed from molded or machined components.

6. The system of claim 1, wherein the book retention slot comprises friction-fit edges configured to secure the book.

7. The system of claim 1, wherein the book retention slot includes an adjustable retention mechanism selected from the group consisting of sliding rails, spring-loaded clamps, elastic tension bands, and telescoping walls.

8. The system of claim 1, wherein each chapter access door is formed by perforated lines enabling punch-through access.

9. The system of claim 1, wherein each chapter access door comprises a hinge selected from the group consisting of a living hinge, a mechanical hinge, and a film hinge.

10. The system of claim 1, wherein each chapter access door includes a magnetic latch, snap-fit latch, friction-fit latch, or key-lock mechanism.

11. The system of claim 1, wherein the chapter access doors are shaped as squares, rectangles, circles, or thematic shapes corresponding to the book's narrative.

12. The system of claim 1, wherein the internal item holder assembly comprises a thermoformed tray having a plurality of recessed compartments.

13. The system of claim 1, wherein the internal item holder assembly comprises a foam insert, molded pulp tray, 3D-printed tray, or multilayer tray.

14. The system of claim 1, wherein the internal item holder assembly includes alignment features selected from the group consisting of alignment ribs, guide rails, keyed positioning tabs, magnetic alignment points, and adhesive or snap-fit mounting structures.

15. The system of claim 1, wherein each compartment includes a retention lip, cushioning material, or protective liner configured to prevent item displacement during shipping.

16. The system of claim 1, wherein the compartments are configured to retain stickers, trinkets, collectibles, foreshadowing tokens, chapter-themed accessories, or any small narrative-related item.

17. The system of claim 1, wherein the system is configured to provide sequential access to items in synchronization with the reader's progression through the book.

18. The system of claim 1, further comprising an electronic module configured to illuminate, unlock, or otherwise activate a chapter access door.

19. The system of claim 1, further comprising an NFC tag, RFID tag, QR code, or digital content trigger associated with one or more chapter access doors.

20. The system of claim 1, wherein the internal item holder assembly is removable, refillable, replaceable, or interchangeable with alternative trays.
